(19) United States
(12) Patent Application Publication
(10) Pub. No.: US 2014/0022606 A1
(43) Pub. Date: Jan. 23, 2014

(54) SCANNING APPARATUS FOR LARGE SCALE DOCUMENT

(71) Applicant: HON HAI PRECISION INDUSTRY CO., LTD., New Taipei (TW)

(72) Inventor: PING-YI CHEN, New Taipei (TW)

(73) Assignee: HON HAI PRECISION INDUSTRY CO., LTD., New Taipei (TW)

(21) Appl. No.: 13/892,670

(22) Filed: May 13, 2013

(30) Foreign Application Priority Data
Jul. 18, 2012 (TW) 101125781

(51) Int. Cl. H04N 1/387; H04N 1/10

(52) U.S. Cl. CPC H04N 1/3876; H04N 1/1013
USPC 358/450; 358/497

(57) ABSTRACT

A scanning apparatus for scanning a large scale document, includes a main body, a scanning sensor, and a document transferring apparatus. The main body includes a transparent document placing portion. The scanning sensor is slidably mounted below the document placing portion. A scale of the scanning sensor is smaller than a scale of the transparent document placing portion. The transparent document placing portion supports the document thereon. The scanning sensor moves in at least two dimensionalities below different portions of the transparent document placing portion to scan different portions of the document.

### BACKGROUND

1. Technical Field

The present disclosure relates to an image forming apparatus, and particularly to a scanning apparatus for large scale documents.

2. Description of Related Art

Generally, a scanner is used to scan documents to form images of the documents. For different sized documents, there exists a need for different kinds of scanners. For example, an A4 size scanner cannot scan an A3 size document because the scale of the scanner is smaller than the scale of the document.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an embodiment of an image forming apparatus.

FIG. 2 is a block diagram of an embodiment of the image forming apparatus of FIG. 1.

FIG. 3 is an isometric view of the image forming apparatus of FIG. 1 with a large scale document at one state.

FIG. 4 is similar to FIG. 3 except shown at another state.

FIG. 5 is a top view of images formed by the image forming apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

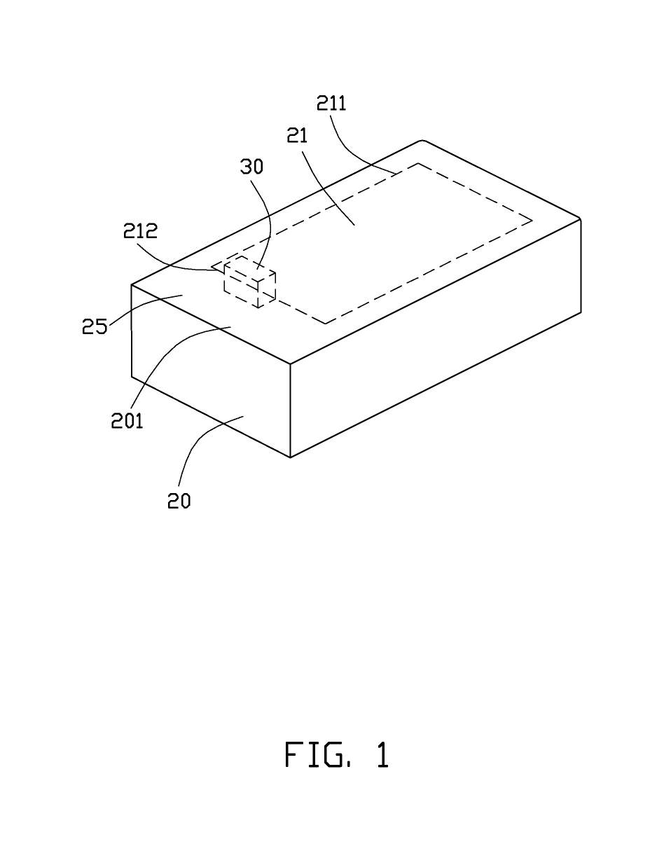

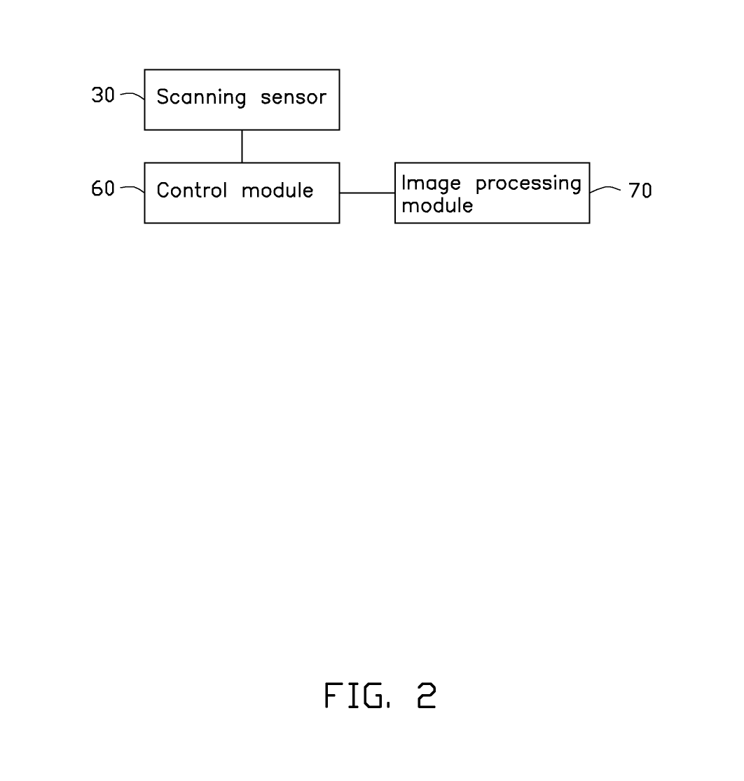

FIGS. 1 and 2 show one embodiment of a scanning apparatus for large scale documents. The scanning apparatus includes a main body 20, a scanning sensor 30, a control module 60, and an image processing module 70. The scanning sensor 30, the control module 60, and the image processing module 70 are mounted in the main body 20.

The control module 60 connects to the scanning sensor 30, and an image processing module 70.

The main body 20 includes a top side 25. The top side 25 includes a transparent document placing portion 21. The document placing portion 21 can be rectangular which includes a pair of long edges 211 and a pair of short edges 212. The scanning sensor 30 is located below the document placing portion 21. A length of the scanning sensor 30 is generally equal to or slightly smaller than half of the short edge 212. A document can be placed on the document placing portion 21 and scanned by the scanning sensor 30. The main body 20 includes a first end 201 and a second end 202.

The scanning sensor 30 slides below the document placing portion 21. The scanning sensor 30 can be aligned to the short edge 212 of the document placing portion 21 and can slide along the long edge 211 and the short edge 212.

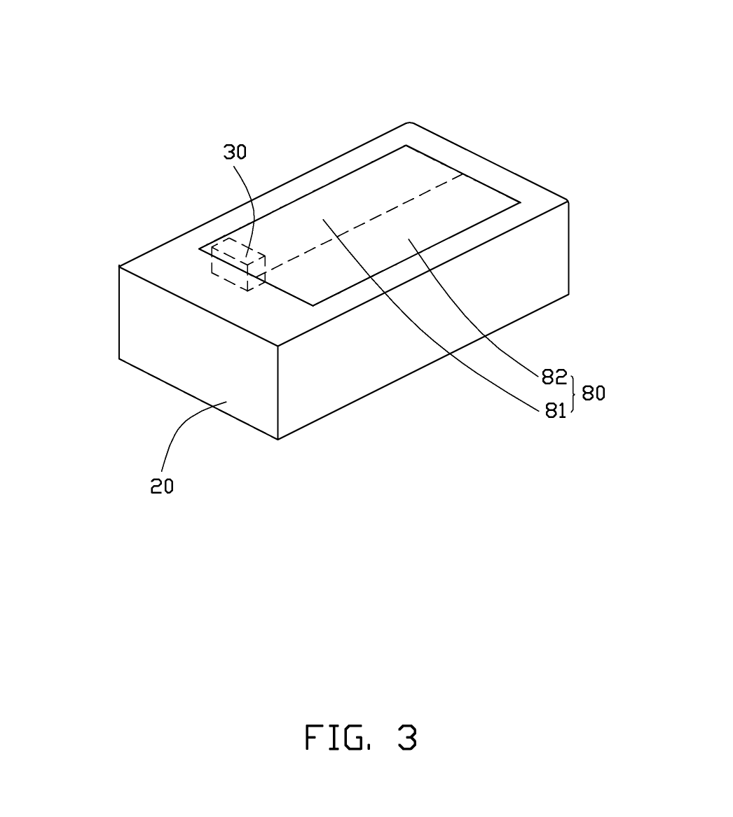

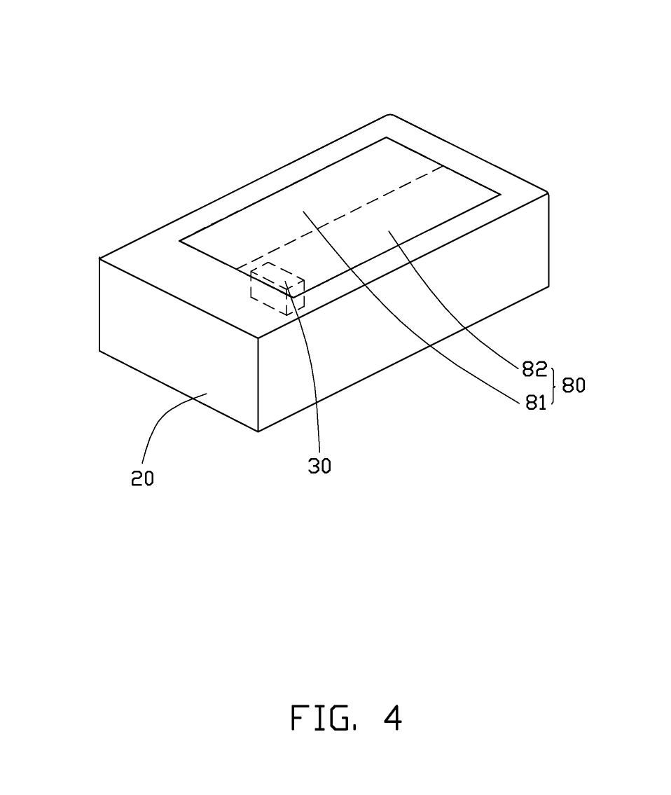

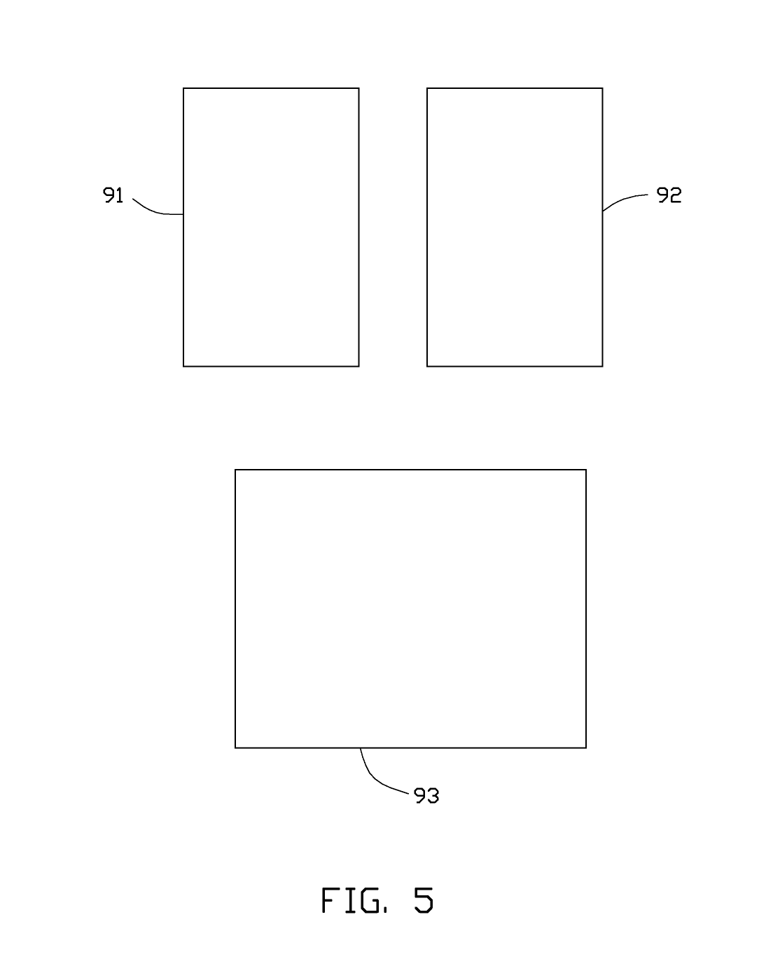

Referring to FIGS. 3 to 5, a large scale document 80 can be scanned by the scanning apparatus. The large scale document 80 is equal to or slightly smaller than the document placing portion 21. The large scale document 80 includes a first portion 81 and a second portion 82. A width of each of the first portion 81 and the second portion 82 is equal to the length of the scanning sensor 30.

At an initiatory position, the scanning sensor 30 is located below the first portion 81 and adjacent the first end 201 to be located at a first position. To scan the document 80, the scanning sensor 30 slides along the long edge 211 from the first end 201 to the second end 202 and below the transparent document placing portion 21 to slide the first portion 81 to get a first image file 91 corresponding to the first portion 81. The scanning sensor 30 is now in a second position. Then, the scanning sensor 30 slides along the short edge 212 to be located below the second portion 82 to be located at a third position. The scanning sensor 20 slides below the second portion 82 from the second end 202 back to the first end 201 to be located at a fourth position. In succession, the scanning sensor 20 moves from the fourth position to the third position to scan the second portion 82 to obtain a second image file 92 corresponding to the second portion 82. The scanning sensor 30 then moves back to the first position to reposition. At last, the image processing module 70 combines the first image file 91 and the second image file to generate a combined image file 93 corresponding to the document 80.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A scanning apparatus for scanning a document, the scanning apparatus comprising:
a main body comprising a transparent document placing portion; and
a scanning sensor slidably mounted below the document placing portion, a scale of the scanning sensor is smaller than a scale of the transparent document placing portion; wherein the transparent document placing portion supports the document thereon, and the scanning sensor is adapted to move in at least two dimensionalities below different portions of the transparent document placing portion to scan different portions of the document.

2. The scanning apparatus of claim 1, wherein the document placing portion comprises a pair of long edges and a pair of short edges, the pair of long edges is substantially perpendicular to the pair of short edges, and the scanning sensor slides along the pair of long edges and the short edges.

3. The scanning apparatus of claim 2, wherein a length of the scanning sensor is equal to half of the short edge

4. The scanning apparatus of claim 1, wherein an area of the document is equal to an area of the document placing portion.

5. The scanning apparatus of claim 4, wherein the document comprises a first portion and a second portion, and the scanning sensor scans the first portion and the second portion in turn.

6. The scanning apparatus of claim 5, wherein the scanning sensor scans the first portion to obtain a first image file, and scans the second portion to obtain a second image file.

7. The scanning apparatus of claim 6, further comprising an image processing module combining the first image file and the second image file to generate a combined image file corresponding to the document.

8. A scanning apparatus for scanning a document, the scanning apparatus comprising:
a main body comprising a transparent document placing portion;
a scanning sensor slidably mounted below the document placing portion; and
an image processing module connected to the scanning sensor;
wherein the transparent document placing portion supports the document thereon, and the scanning sensor is adapted to move in at least two dimensionalities below different portions to scan different portions of the document to generate different image files, and the image processing module combines the image files into one combined image file.

9. The scanning apparatus of claim 8, wherein the document placing portion comprises a pair of long edges and a pair of short edges, the pair of long edges is substantially perpendicular to the pair of short edges, and the scanning sensor slides along the pair of long edges and pair of short edges.

10. The scanning apparatus of claim 9, wherein a length of the scanning sensor is equal to half of the short edge.

11. The scanning apparatus of claim 9, wherein an area of the document is equal to an area of the document placing portion.

12. The scanning apparatus of claim 11, wherein the document comprises a first portion and a second portion, and the scanning sensor scans the first portion and the second portion in turn.

13. The scanning apparatus of claim 12, wherein the scanning sensor scans the first portion to obtain a first image file, and scans the second portion to obtain a second image file.

14. The scanning apparatus of claim 13, wherein the image processing module combines the first image file and the second image file to generate a combined image file corresponding to the document.
